(19) United States
(12) Patent Application Publication
(10) Pub. No.: US 2011/0280515 A1
(43) Pub. Date: Nov. 17, 2011

(54) COUPLED PLASMONIC WAVEGUIDES AND ASSOCIATED APPARATUSES AND METHODS

(75) Inventors: Eric J. Black, Monroeville, PA (US); James A. Bain, Pittsburgh, PA (US); Stephen P. Powell, Pittsburgh, PA (US); Tuviah E. Schlesinger, Mt. Lebanon, PA (US)

(73) Assignee: Carnegie Mellon University, Pittsburgh, PA (US)

(21) Appl. No.: 12/780,207

(22) Filed: May 14, 2010

(51) Int. Cl. G02B 6/42

(52) U.S. Cl. 385/31

(57) ABSTRACT

An apparatus and corresponding method in which the apparatus includes a dielectric waveguide and a metallic waveguide. The dielectric waveguide has an effective mode index and a longitudinal dimension. The metallic waveguide has a longitudinal dimension and supports a surface plasmonic mode of propagation for a wavelength lambda. The metallic waveguide and the dielectric waveguide are adjacent to each other and overlap each other by a length along the longitudinal dimensions of both the dielectric waveguide and the metallic waveguide, wherein the length is greater than the wavelength lambda in the metallic waveguide. The metallic waveguide is coupled to the dielectric waveguide where the metallic waveguide and the dielectric waveguide overlap each other.

### CROSS-REFERENCE TO RELATED APPLICATIONS

Not Applicable.

### STATEMENT REGARDING FEDERALLY-SPONSORED RESEARCH AND DEVELOPMENT

Not Applicable.

### FIELD OF THE INVENTION

The present invention is directed generally to coupled plasmonic waveguides and associated apparatuses and methods such as, for example, apparatuses and methods for coupled plasmonic waveguide transducers and near field optical sources.

### BACKGROUND OF THE INVENTION

Optical near field writing (as in for example an information storage system that records data with the use of an optical spot) applications often require both high power throughput and well confined optical spots. There have been published papers describing a variety of near field transducers (“NFT”s) for confining light for applications including heat assisted magnetic recording. It has been proposed that these transducers can be illuminated with focused optical spots and with optical modes carried in waveguides. In most cases, though, the NFT is a discrete element that is best modeled as a lumped element that is illuminated with a propagating electromagnetic wave and responds by concentrating the incoming field. This often results in a rather severe impedance mismatch and significant power dissipation in the rather small transducer, raising its temperature to an unacceptable level.

In contrast to near field devices and optical elements far field optics and dielectric waveguide structures enjoy high throughput but lack the ability to spatially confine the optical spot as desired. In the case of far field optics, the diffraction limit restricts the spot diameter to approximately λ/NA where λ is the free space wavelength and NA is the numerical aperture of the optical system [See W. A. Challener*, Chubing Peng, A. V. Itagi, D. Karns, Wei Peng, Yingguo Peng, XiaoMin Yang, Xiaobin Zhu, N. J. Gokemeijer, Y.-T. Hsia, G. Ju, Robert E. Rottmayer, Michael A. Seigler and E. C. Gage “Heat-assisted magnetic recording by a near-field transducer with efficient optical energy transfer”, Nature Photonics, (2009)]. A dielectric waveguide can have core dimensions that are smaller than a diffraction limited spot. However, as the waveguide cross section is reduced, the effective mode index approaches cutoff. Near cutoff the waveguide becomes weakly guiding, with much of the optical power travelling outside the core. The net result is that the dielectric waveguide structure can not significantly reduce spot size below the diffraction limit.

Metallic apertures and antennae can confine the light well. However at sub-wavelength dimensions the efficiency of these structures can be quite poor. The efficiency of a simple aperture in a metal plane scales as (d/λ)⁴ where d is the diameter of the aperture [See H. A. Bethe, “Theory of Diffraction by Small Holes” Phys. Rev. 66, 163 (1944)]. More sophisticated structures such as the tapered metallic waveguides employed by scanning near field optical microscopes show efficiencies on the order of 10⁻⁶ to 10⁻⁴ [See K. Sendur, C. Peng, W. Challener “Near-Field Radiation from a Ridge Waveguide Transducer in the Vicinity of a Solid Immersion Lens”, Phys. Rev. Letters, 94, (2005)]. Metallic structures can become difficult to analyze at optical frequencies as the perfect conductor approximation breaks down. Real metals at optical frequencies exhibit complex dielectric behavior that is further complicated when shaping the metals into sub-wavelength structures.

One application of devices as described above used to confine optical spots is Heat Assisted Magnetic Recording (“HAMR”). HAMR requires the delivery of concentrated optical spots whose spatial extent is substantially smaller than optical wavelengths. A number of publications have shown different schemes for accomplishing this. All of the work reported in these publications has relied on metallic structures that act as near field optical transducers to collect and confine the optical power. These near field transducers (NFT's) have been shown (both in modeling and experiment) in many forms including the ridge waveguide [See, A. Itagi, D. Stancil, J. Bain, and T. Schlesinger, Applied Physics Letters, vol. 83, December 2003, pp. 4474-6][See, B. C. Stipe, J. Thiele, C. Poon, T. Strand, and B. Terris, Presented at INTERMAG 2006, May 8-12, San Diego, Calif.] or equivalently, the “C-aperture”[See, X. Shi and L. Hesselink, Journal of the Optical Society of America B: Optical Physics, vol. 21, 2004, pp. 1305-1317], the resonant disk or “lollipop”[See, W. A. Challener, C. Peng, A. V. Itagi, D. Karns, W. Peng, Y. Peng, X. Yang, X. Zhu, N. J. Gokemeijer, Y. Hsia, G. Ju, R. E. Rottmayer, M. A. Seigler, and E. C. Gage, Nat Photon, vol. 3, April 2009, pp. 220-224.], the triangular aperture [M. Hirata, M. Oumi, K. Shibata, K. Nakajima, and T. Ohkubo, IEICE Transactions on Electronics, vol. E90C, 2007, pp. 102-9.], the nanobeak [See, T. Matsumoto, K. Nakamura, T. Nishida, H. Hieda, A. Kikitsu, K. Naito, and T. Koda, Appl. Phys Lett, vol. 93, 2008, pp. 031108-1.] and the dimple lens [See, S. Vedantam, Hyojune Lee, Japeck Tang, J. Conway, M. Staffaroni, Jesse Lu, and E. Yablonovitch, Plasmonics: Metallic Nanostructures and Their Optical Properties V, 26 Aug. 2007, p. 66411J.]. In the prior art cited above, illumination of the NFT with focused light as well as with propagating modes within waveguides are described. FIG. 1 illustrates the latter type of illumination for a generic NFT 1 in which optical power 2 is input to a waveguide core 3. The NFT 1 focuses energy to create a hot spot 4 in some medium upon which the optical field is incident. The waveguide core 3 is enclosed in a waveguide cladding 5.

Many of these prior art devices can accomplish adequate confinement of the field, which is their first order task. Once this has been proven, additional performance metrics arise, such as the degree of heating in the NFT compared to the media, the sensitivity of the transducer to process variation, to dimensional control, and to recording parameters such as fly height. The prior art, however, has significant shortcomings in these or other areas, such as those described above.

Accordingly, there is a need for improved apparatuses and methods for producing improved power throughput and better confined optical spots. Those and other advantages of the present invention will be described in more detail herein below.

### BRIEF SUMMARY OF THE INVENTION

According to one embodiment, the present invention includes an apparatus with a dielectric waveguide and a metallic waveguide. The dielectric waveguide has an effective mode index and a longitudinal dimension. The metallic waveguide has a longitudinal dimension and

supports a surface plasmonic mode of propagation for a wavelength lambda. The metallic waveguide and the dielectric waveguide are adjacent to each other and overlap each other by a length along the longitudinal dimensions of both the dielectric waveguide and the metallic waveguide, wherein the length is greater than the wavelength lambda in the metallic waveguide. The metallic waveguide is coupled to the dielectric waveguide where the metallic waveguide and the dielectric waveguide overlap each other. As used herein, “coupled”, means the transfer of energy from a mode of the dielectric waveguide to a mode of the metallic waveguide. “Coupled” includes the case in which the waveguides are matched to each other, although the waveguides can be coupled without being matched.

The present invention also includes methods for coupling energy between dielectric and metallic waveguides. The method may include, for example, the steps of introducing electromagnetic energy in a dielectric waveguide having an effective mode index, wherein the electromagnetic energy propagates along a longitudinal dimension of the dielectric waveguide; coupling the electromagnetic energy from the dielectric waveguide to a metallic waveguide at a location where the metallic waveguide and the dielectric waveguide are adjacent to each other and overlap each other by a length along the longitudinal dimensions of both the dielectric waveguide and the metallic waveguide, wherein the length is greater than the wavelength lambda in the metallic waveguide; and propagating the electromagnetic energy along a longitudinal dimension of the metallic waveguide, wherein the electromagnetic energy is in a surface plasmonic mode of propagation in the metallic waveguide and at a wavelength lambda. Other variations and modifications of the method are also possible according to the present invention.

The present invention can also include or be embodied as computer-readable instructions such as software, firmware, hardware, and other embodiments which, when executed by a processor, causes the processor to perform certain actions according to the present invention. In one embodiment, the present invention includes an apparatus including a processor, memory, an input device, and an output device. The memory includes computer-readable instructions which, when executed, cause the processor to perform the methods described herein, and the computer-readable instructions may be used, for example, to control an energy source and/or other parts of an apparatus according to the present invention.

The present invention may be used to direct energy into a spot that is smaller than the free-space wavelength of the energy at optical frequencies. This highly focused energy may be used, for example, to heat the magnetic surface layer of a hard disk drive or other magnetic information storage devices. This thermal spot provides assistance to the magnetic writing process in the mode of heat assisted magnetic recording (HAMR).

In contrast to the prior art, the present invention excites propagating plasmonic modes in a distributed fashion, allowing for smaller impedance mismatch at the point of spot localization. The present invention is also amenable to measurement of its plasmonic dispersion relationship, allowing the actual properties of the transducer to be measured relatively easily. With these measurements in hand, the dielectric illuminating structures can be tuned accordingly. Thus, this approach allows for the idea that the transducer need not have a specific shape, just a consistent one that can be deduced from a real fabricated device and matched or coupled with the dielectric waveguide. This may make for more robust design, fabrication and test cycles.

The present invention also presents new ways to couple energy traveling in a dielectric waveguide (with dimensions comparable to the wavelength of light) into, for example, a near field transducer that concentrates the light to a much smaller dimension. The present invention also includes novelty in the geometry of the apparatus, the coupling to the dielectric waveguide, and in the use of guided plasmonic modes to focus the light.

The present invention also offers advantages over the prior art including the ability to manage the thermal load on the transducer, relatively simple fabrication that is commercially attractive, and tolerance to manufacturing variations.

Many variations are possible with the present invention, and those and other teachings, variations, and advantages of the present invention will become apparent from the description and figures of the invention.

### BRIEF DESCRIPTION OF THE SEVERAL VIEWS OF THE DRAWING

Embodiments of the present invention will now be described, by way of example only, with reference to the accompanying drawings for the purpose of illustrating the embodiments, and not for purposes of limiting the invention, wherein:

FIG. 1 illustrates the illumination of a near field transducer with a single mode dielectric waveguide according to the prior art.

FIGS. 2 and 3 illustrate embodiments of apparatuses according to two embodiments of the present invention.

FIGS. 4-12 illustrates embodiments of dielectric and metallic waveguides according to several embodiments of the present invention.

FIG. 13a illustrates a tapered dielectric waveguide suitable for creation of single mode illumination of the near field transducer according to the present invention.

FIG. 13b illustrates a schematic of the cross-section of the waveguide including the coupling grating.

FIG. 13c illustrates a view of the grating illuminated with a laser spot.

FIG. 14a illustrates peak temperature of media as a function of fly height and wavelength of illuminating light per unit of input power into the dielectric waveguide.

FIG. 14b illustrates peak temperature of the near field transducer as a function of fly height and wavelength of illuminating light per unit of input power into the dielectric waveguide.

FIG. 15 illustrates one embodiment of a calculated plasmon resonance condition shown as fraction of power absorbed for a SiNx/SiO2/Gold stack as a function of incident angle and SiO2 thickness in the Otto geometry. The resonance absorbs most of the power at 57 degree incidence with a 220 nm thick SiO2 layer.

FIG. 16 illustrates power carried normal to the plane by the SP mode of a gold wire surrounded SiO2 according to one embodiment of the present invention. The region inside the circle is Au, and the contours correspond to power density, with two intensity peaks on the top and bottom of the Au.

FIG. 17 illustrates contours of power carried normal to the plane of the figure by dielectric waveguide (rectangle).

FIG. 18 illustrates one embodiment of the present invention in which a TM electromagnetic wave enters from the left in the dielectric waveguide. The waveguide couples into the wire over length L_{C} and back out again over length L_{C}.

FIG. 19 illustrates an oblique view of the plasmonic waveguide positioned for coupling from the dielectric waveguide. Only a halfspace is shown, as the problem is symmetric about the centerline. The plasmonic mode carries the power along the narrow ridge of the waveguide.

FIG. 20 illustrates power dissipation in the media from a trapezoidal wire according to one embodiment of the present invention.

FIG. 21a illustrates a plot of the normalized temperature (T/Tₘₐₓ) and the normalized dissipated power (P/Pₘₐₓ) in the media resulting from the use of the coupled plasmonic waveguide for the delivery of power according to one embodiment of the present invention. The thermal profile is wider than the power profile due to non-optimized thermal conductivity in the media stack.

FIG. 21b shows a 2-D map with contours of media temperature, with the hottest spot being at the bottom corner of the triangular transducer.

FIG. 22 illustrates a plot of the temperature of the metallic waveguide and the media as a function of position along the waveguide according to one embodiment of the present invention. Results are shown for two different values of the thermal conductivity of the dielectric surrounding the plasmonic waveguide,

FIG. 23a illustrates possible variations of cross section of plasmonic waveguides.

FIG. 23b illustrates that variations may also include beaks or other protrusions to help in field confinement in contact with the media.

FIG. 24 illustrates a method according to one embodiment of the present invention.

FIG. 25 illustrates another embodiment of the apparatus according to the present invention.

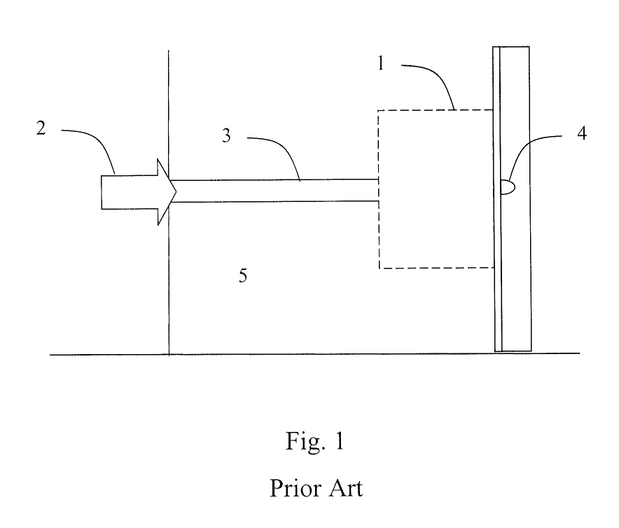

### DETAILED DESCRIPTION OF THE INVENTION

The present invention will generally be described in terms of coupled plasmonic waveguides and associated apparatuses and methods such as, for example, apparatuses and methods for coupled plasmonic waveguide transducers and near field optical sources. The present invention will also generally be described in terms of use in magnetic information storage devices, although the present invention is not limited to such devices and may be used with other applications such as, for example, generating small, intense optical spots for imaging or surface modification, or for other applications. Finally, the present invention includes many modifications and variations, and the specific descriptions and embodiments provided herein are illustrative of the present invention and not limiting. The present invention will be described in terms of both experimental examinations of the illumination structure and simulations of the near field transducer.

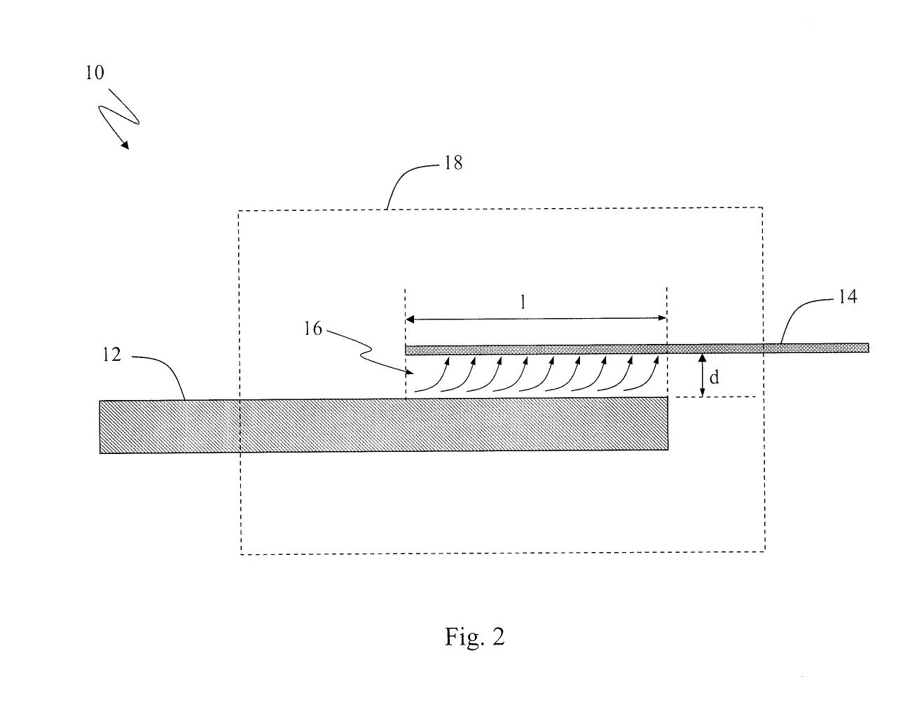

FIG. 2 illustrates one embodiment of an apparatus 10 according to the present invention. The apparatus 10 in the illustrated embodiment is a coupled plasmonic waveguide which may be used, for example, as a coupled plasmonic waveguide transducer, a near field transducer, or a near field source. The apparatus 10 includes first 12 and second 14 waveguides, which will generally be described as a dielectric waveguide 12 and a metallic waveguide 14.

The waveguides 12, 14 will sometimes be described as having a longitudinal dimension. The longitudinal dimension of a waveguide is the dimension along which the energy propagates when traveling from the input of the waveguide to the output of the waveguide. This is typically, but not always, the longest dimension of the waveguide 12, 14. However, it is possible for the present invention to be used with waveguides in which the energy propagates along a dimension that is not the largest dimension of the waveguide and, in such embodiments, the “longitudinal” dimension may not be the largest dimension of the waveguide. Furthermore, other terms understood by those of skill in the art in light of the disclosure will sometimes be used herein. For example, the metallic waveguide 14 will sometimes be referred to as a “plasmonic waveguide” or a “wire”. Furthermore, although the present invention will generally be described in terms of a single dielectric waveguide 12 and a single metallic waveguide 14, the present invention may also be used with more than one dielectric waveguide 12 and/or more than one metallic waveguide 14.

The dielectric waveguide 12 typically has a larger cross-sectional area than the metallic waveguide 14, and the present invention will be described as apparatuses and methods for coupling energy 16 from the larger dielectric waveguide 12 to the smaller metallic waveguide 14. However, it is possible for a dielectric waveguide 12 to be smaller than the metallic waveguide 14 in one or more places such as, for example, if the cross-sectional areas of the dielectric 12 and/or metallic 14 waveguides are not constant along their longitudinal dimensions.

The present invention describes apparatuses and methods to effectively couple energy 16 from the larger waveguide 12 to the smaller waveguide 14, thereby allowing for improved power throughput and better confined optical spots when the energy is output from the metallic waveguide 14. The energy used in connection with the present invention will generally be described as energy in the visible spectrum for the purposes of describing particular embodiments of the present invention. However, the present invention is not limited to use with only energy in the visible spectrum and other parts of the electromagnetic spectrum, particularly the infrared and ultraviolet regimes may also be used with the present invention.

In the illustrated embodiment the dielectric waveguide 12 has a longitudinal dimension which is oriented horizontally, and waves in the waveguide 12 travel from left to right in the figure along the longitudinal (i.e., horizontal) dimension of the waveguide 12. The dielectric waveguide 12 also has an effective mode index.

The dielectric waveguide 12 may be, for example, fiber optic cable, or planar optoelectronic system such as a photonic integrated circuit or thin film waveguides. The dielectric waveguide 12 may have a variety of shapes such as that of a fiber optic strand having a circular or oval cross-sectional shapes, or other forms having other cross-sectional shapes such as, for example, rectangular cross-sectional shapes or other cross-sectional shapes.

The metallic waveguide 14 also has a longitudinal dimension which is also oriented horizontally in the figure. Energy 16 coupled from the dielectric waveguide 12 into the metallic waveguide 14 travel from left to right in the figure along the longitudinal (i.e., horizontal) dimension of the metallic waveguide 14.

The metallic waveguide 14 may be a wire made from one of a wide variety of metals such as, for example, Gold, Silver or Copper The metallic waveguide 14 may have a variety of shapes such as a circular cross-sectional shape, or other cross-sectional shapes such as rectangular, triangular, T-shaped, X-shaped, oval, or ‘v’ or ‘u’ grooved.

The metallic waveguide 14 supports a surface plasmonic mode of propagation for a wavelength lambda. The surface plasmonic mode of propagation in the metallic waveguide 14 has an effective mode index, and the effective mode index of the surface plasmonic mode of propagation is matched to the effective mode index of the dielectric waveguide 12. The matching is never ‘exact’ in practice. A mismatched mode index will limit the maximum possible energy coupling and extend the required coupling length. Furthermore, the present invention may be used in embodiments in which the surface plasmonic mode of propagation is mismatched to the effective mode index of the dielectric waveguide 12. This may be an intentional design feature in which a detuned device is desired, or it may be the result of a manufacturing variation that is within acceptable limits that still provides a useful device.

The metallic waveguide 14 and the dielectric waveguide 12 overlap each other by a length “l” along the longitudinal dimensions of both the dielectric waveguide 12 and the metallic waveguide 14. In other words, if the waveguides 12, 14 are both wire-shaped, then they are adjacent to each other and side-by-side for a distance “l”. This overlap between the dielectric waveguide 12 and the metallic waveguide 14 is a region where energy is coupled 16 between the waveguides 12, 14.

When the waveguides 12, 14 are adjacent to each other they are at a distance such that, when operated and constructed according to the present invention, energy at wavelength lambda is coupled from the dielectric waveguide 12 to the metallic waveguide 14. If energy will not couple between the waveguides 12, 14 when constructed and operated according to the present invention, then the waveguides are not adjacent.

In some embodiments the waveguides 12, 14 are both adjacent and parallel to each other, and in other embodiments the waveguides 12, 14 are adjacent to each other and not parallel (e.g., waveguides 12, 14 are closer to each other at one point and farther away from each other at another point). The waveguides 12, 14 may also be non-linear or have non-flat surfaces, thereby making for a more complex arrangement of the surfaces of the waveguides 12, 14.

The length “l” of the overlap is greater than lambda and, in some cases, the length “l” may be much greater than lambda. The precise value of “l” will vary depending on the particular application of the present invention. If “l” is too short, then the energy may not be effectively coupled from the dielectric waveguide 12 to the metallic waveguide 14. If “l” is too long, energy may be coupled from the dielectric waveguide 12 to the metallic waveguide 14, and then some of the energy may be coupled from the metallic waveguide 14 back into the dielectric waveguide 12, which may be undesirable in some applications.

The metallic waveguide 14 is separated from the dielectric waveguide 12 by a distance “d” when the waveguides 12, 14 overlap. This distance between the waveguides 12, 14 is such that energy at wavelength lambda will be coupled from the dielectric waveguide 12 to the metallic waveguide 14. The distance is an important factor in coupling of energy between the waveguides 12, 14, although it is not the only factor. For example, the length “l”, the orientation of the waveguides relative to each other, characteristics of the waveguides 12, 14 and other factors can affect the coupling of energy between the waveguides 12, 14.

The distance between the waveguides 12, 14 need not be constant through the entire overlap region. For example, the distance “d” may vary slightly or greatly in the overlap region. This variation may be inadvertent, such as variations due to the manufacturing process, or the variation may be intentional. For example, the coupling between the waveguides 12, 14 may be tuned by adjusting the distance between the waveguides 12, 14 along a portion of the overlap length “l”. In other embodiments, the distance “d” may be adjusted along the entire overlap length “l”, as opposed to only a portion of the length “l”. Similarly, the length “l” of the overlap may also be increased or decreased to adjust the operation of the apparatus 10.

The waveguides 12, 14 may be encased in a dielectric material 18 in order to maintain the orientation and spacing of the waveguides relative to each other. In another embodiment, the dielectric material 18 may be placed between the waveguides 12, 14 to maintain the orientation and spacing, but the dielectric materials 18 is not otherwise used to surround the waveguides 12, 14. This dielectric material 18 may be, for example, air, silicon dioxide (glass), quartz, tantalum oxide, silicon nitride, diamond-like carbon, SPO₂, TaO₂, MN, Al₂O₃, and other oxides and nitrides.

Many variations are possible with the present invention. For example, although metallic waveguide 14 is illustrated as extending beyond both the dielectric material 18 and the dielectric waveguide 12, the metallic waveguide 14 may be flush with the dielectric material 18 or recessed into the dielectric material 18. Also, the dielectric waveguide 12 is illustrated as being recessed into the dielectric material 18, although the dielectric waveguide 12 may be flush with or extending beyond the dielectric material 18. Other variations and modifications are also possible.

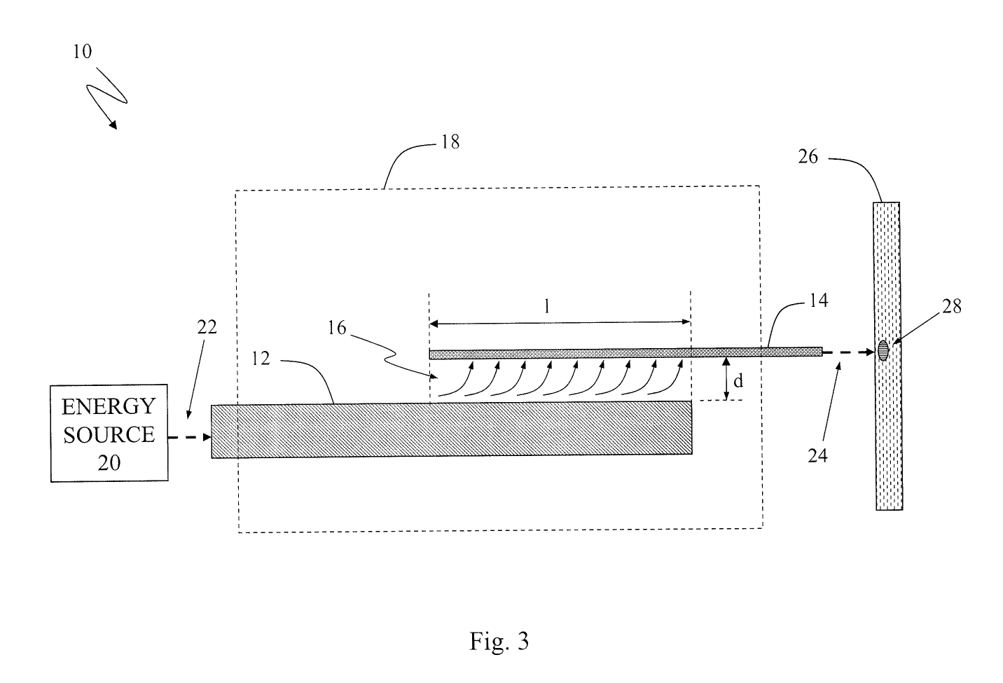

FIG. 3 illustrates another embodiment of an apparatus 10 according to the present invention including an energy source 20 and a target 26. This embodiment 10 of the present invention may be used, for example, as a near field optical source or a near field transducer acting on the target 26.

The energy source 20 provides energy 22 into the dielectric waveguide 12. For example, the energy source 20 may have an output oriented to couple energy, directly or indirectly, into an input of the dielectric waveguide 12. The energy source 20 may be, for example, a laser, a light emitting diode, a superluminescent diode, or other sources of electromagnetic energy. In general, sources of single or narrow range of wavelengths of energy are preferable, although other sources of energy may also be used.

The energy 22 enters the dielectric waveguide 12, travels from left to right down the dielectric waveguide 12, energy 16 is coupled from the dielectric waveguide 12 to the metallic waveguide 14 and travels from left to right down the metallic waveguide 14, and energy 24 exits the metallic waveguide 14 in the direction of a target 26.

The energy 24 exiting the metallic waveguide 14 is expected to be at least slightly less than the energy 22 entering the dielectric waveguide 12 due to losses in the waveguides 12, 14 and losses in the coupling 16 process. The extent of the losses will vary with the particular set-up of the apparatus 10, and the losses may be offset or reversed if, for example, there is another source of energy in the apparatus 10. The energy may be essentially unchanged in form as it travels through the apparatus 10, or it may undergo one or more significant changes in form as it travels through the apparatus 10 such as, for example, changes in the frequency and bandwidth due to, for example, dispersion and other effects caused by the energy traveling through the apparatus 10.

The target 26 may be, for example, magnetic media, photoresistive polymer, phase change media, another waveguide, or some other target or media for the energy 24 exiting the metallic waveguide 14. In some embodiments, such as when the target 24 is magnetic media, photoresistive polymer, phase change media, or other materials, the energy hits the target 24 and creates a hot spot 28 on the target 24. In other embodiments, such as when the target 24 is another waveguide, the energy enters the target 26 with little or no hot spot 28 on the target 24. The target 24 is oriented to receive energy from an output of the metallic waveguide 14.

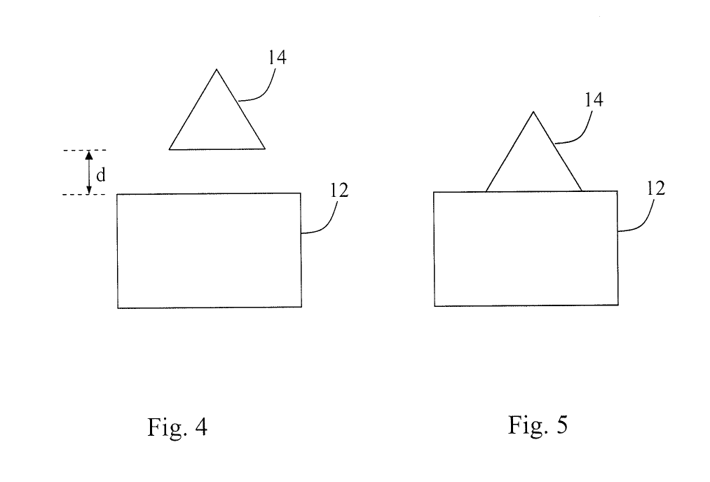

FIG. 4 is a cross-sectional view of one embodiment of the present invention in which the dielectric waveguide 12 and the metallic waveguide 14 are separated from each other. In that embodiment, the dielectric waveguide 12 has a rectangular shape and the metallic waveguide 14 has a triangular cross-sectional shape, although other shapes are also possible with the present invention.

FIG. 5 is a cross-sectional view of another embodiment of the present invention in which the dielectric waveguide 12 and the metallic waveguide 14 are in contact with each other. The illustrated embodiment shows a flat surface of the metallic waveguide 14 in contact with a flat surface of the dielectric waveguide 12. However, the metallic waveguide 14 may also be recessed into the dielectric waveguide 12, or one or both of the waveguides 12, 14 may contact the other with a non-flat surface, such as a curved surface, a notched surface, or an irregular surface.

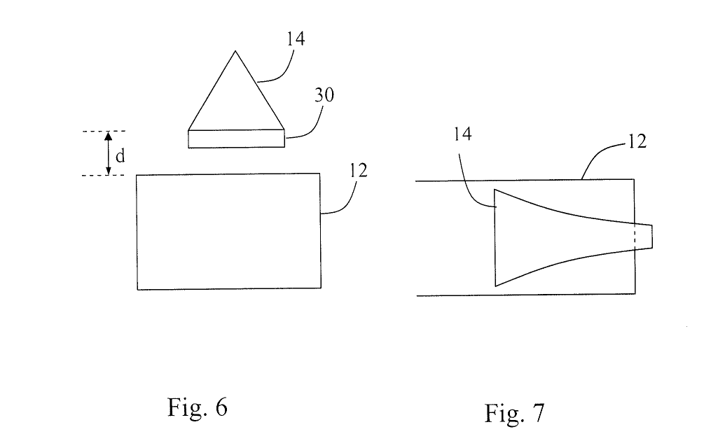

FIG. 6 is a cross-sectional view of another embodiment of the present invention in which the dielectric waveguide 12 and the metallic waveguide 14 are separated from each other and the metallic waveguide 14 includes a dielectric material 30 on a surface of the metallic waveguide 14 between the metallic waveguide 14 and the dielectric waveguide 12.

In the illustrated embodiment the metallic waveguide 14 has a triangular shape with a flat surface oriented towards the dielectric waveguide 12. The metallic waveguide 14 also has an angled surface oriented away from the dielectric waveguide 12. The dielectric material 30 is on the flat surface oriented towards the dielectric waveguide 12.

The dielectric material 30 prevents plasmonic modes on the surface of the metallic waveguide in contact with the dielectric material 30. As a result, in the illustrated embodiment the surface plasmonic mode of propagation in the metallic waveguide 14 is on the angled surface of oriented away from the dielectric waveguide 12.

Although the dielectric waveguide 12 has a rectangular shape and the metallic waveguide 14 has a triangular cross-sectional shape in this embodiment, other shapes are also possible with the present invention. Furthermore, although in this embodiment the dielectric waveguide 12 and the metallic waveguide 14 are separated from each other, it is also possible for the metallic waveguides 14 to be in contact with the dielectric waveguide 12 at the dielectric material 30.

FIG. 7 illustrates another embodiment of the metallic waveguide 14 having a tapered shape. In that embodiment metallic waveguide 14 is shown in front of the dielectric waveguide 12 in order to more clearly illustrate the shape of the metallic waveguide 14. In that embodiment, the metallic waveguide 14 is not a uniform wire shape, but rather has a non-uniform shape. The metallic waveguide 14 may support more than one mode of propagation on the left side of the metallic waveguide 14, and it may support fewer modes of propagation on the more narrow right side of the metallic waveguide 14. In such an embodiment, energy propagation from left to right may exist in more than one mode on the left side of the metallic waveguide 14, and that energy may combine into fewer modes as it propagates from left to right in the metallic waveguide 14. In addition, some energy may leave the metallic waveguide 14 and be lost to the device 10 while propagating from left to right in the metallic waveguide 14. In this embodiment the dielectric waveguide 12 is illustrated as having a rectangular shape, although the dielectric waveguide 12 may also have other shapes such as, for example, a tapered shape corresponding to the metallic waveguide 14 or other shapes.

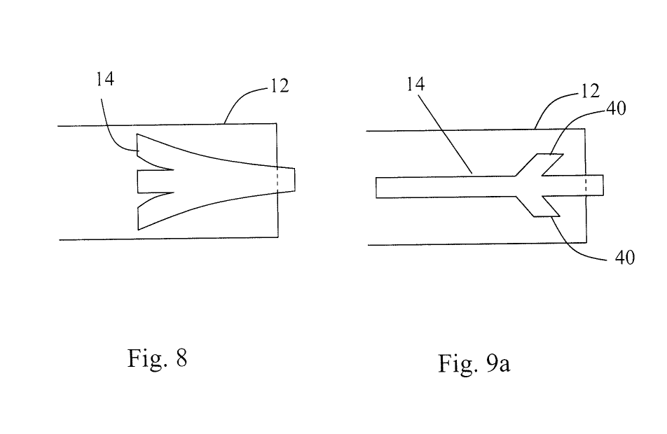

FIG. 8 illustrates another embodiment of the metallic waveguide 14 with the dielectric waveguide 12 in the background. In that embodiment, the metallic waveguide 14 includes several separate paths on the left side of the waveguide 14 which combine to form a single path on the right side of the waveguide 14. The separate paths on the left side of the waveguide 14 each may support the same mode or modes, or a different mode or modes, of propagation on the left side of the metallic waveguide 14, and the energy in those modes may be combined as they propagate from left to right.

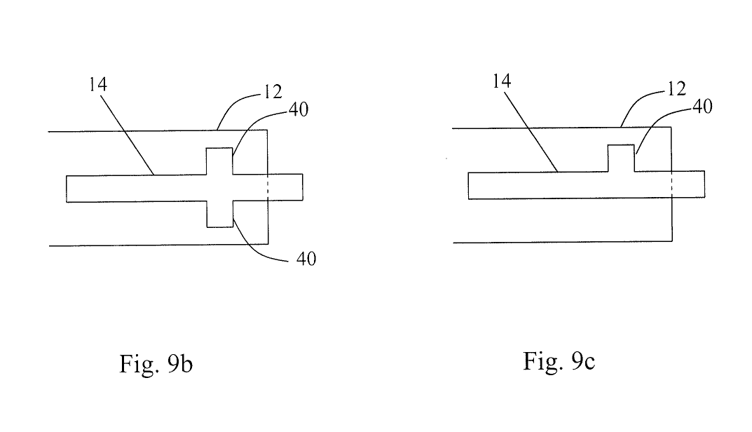

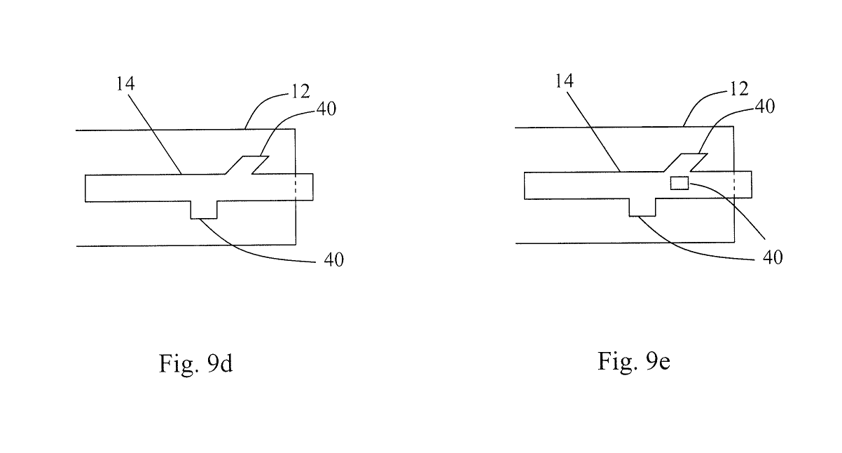

FIG. 9a illustrates another embodiment of the metallic waveguide 14 with the dielectric waveguide 12 in the background. In that embodiment, the metallic waveguide 14 includes tuning features 40 that facilitate matching. The metallic waveguide 14 may be matched, for example, to the target 26 or a load (e.g., a medium) or the metallic waveguide 14 may be matched to the dielectric waveguide 12. In one embodiment, the metallic waveguide 14 includes one or more tuning features 40 to facilitate impedance matching and energy transfer to the target 26. In other embodiments, the metallic waveguide 14 includes one or more tuning features 40 to facilitate impedance matching and energy transfer to the dielectric waveguide 12. The tuning features 40 may be physically attached to the metallic waveguide 14, or the tuning features 40 may not be physically attached to the metallic waveguide 14. Several variations will now be described.

In the illustrated embodiment, the features 40 are illustrated as two “stubs” of the same size extending at approximately a 45 degree angle from the metallic waveguide 14 and forming a symmetrical waveguide 14 structure. However, there may be more or fewer than two features 40, and the features may have shapes and orientations other than those shown herein. The particular shape, orientation, and number of features, and the symmetrical or asymmetrical shape of the waveguide 14 and features 40, will depend on the particular application of the apparatus 10. Furthermore, although the features are shown being used with a metallic waveguide 14 that is otherwise straight and uniform, other variations of the metallic waveguide 14 may also be used.

FIG. 9b illustrates another embodiment of the metallic waveguide 14 in which the features or stubs 40 extend at approximately 90 degree angles from the main body of the waveguide 14.

FIG. 9c illustrates another embodiment of the metallic waveguide 14 in which the features or stubs 40 are on only one side of the metallic waveguide 14. Although this embodiment shows a single feature 40 oriented at a 90 degree angle, more than one feature 40 may also be present on a single side of the waveguide 14, and one or more of the features may also be at angles other than 90 degrees.

FIG. 9d illustrates another embodiment of the metallic waveguide 14 in which there is a feature on both sides of the metallic waveguide 14, but those features 40 are not symmetrical. Although this embodiment shows a single feature 40 on each side of the waveguide 14, more than one feature 40 may also be present on one or more sides of the waveguide 14.

FIG. 9e illustrates another embodiment of the metallic waveguide 14 in which there is a feature on both sides of the metallic waveguide 14 and a feature on the top surface of the metallic waveguide 14. Other variations are also possible, such as a metallic waveguide 14 in which there is also a feature 40 on the bottom surface of the metallic waveguide 14.

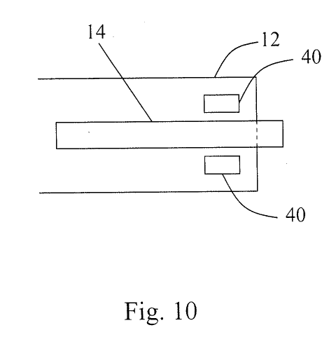

FIG. 10 illustrates another embodiment of the metallic waveguide 14 with the dielectric waveguide 12 in the background. In that embodiment, the apparatus 10 includes features 40 that facilitate matching. However, in this embodiment the features are separate from the metallic waveguide 14. In the illustrated embodiment there are two features, although there may be more or fewer than two features and the features may have shapes and orientations other than those shown herein. The particular shape, orientation, and number of features, and the symmetrical or asymmetrical shape of the waveguide 14 and features 40, will depend on the particular application of the apparatus 10. For example, variations in the features 40 attached to the waveguide 14 and features not attached to the waveguide 14 may be varied as described above with regard to FIGS. 9a-9e, as well as in other variations Furthermore, the present invention may include both one or more features 40 attached to the metallic waveguide 14 and one or more features 40 separate from the metallic waveguide 14. Although the features are shown being used with a metallic waveguide 14 that is otherwise straight and uniform, other variations of the metallic waveguide 14 may also be used.

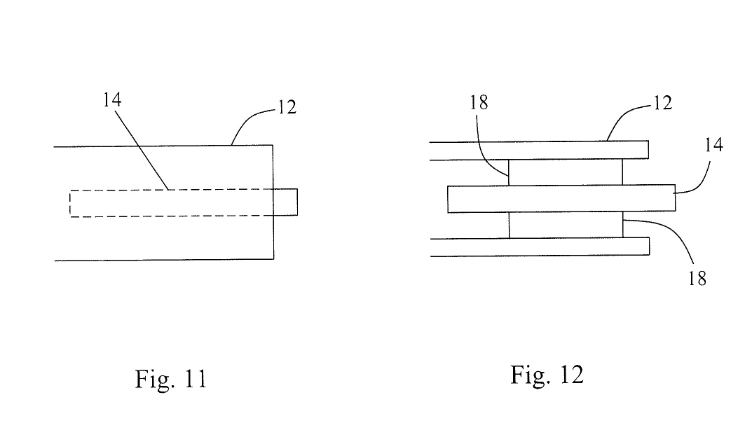

FIG. 11 illustrates another embodiment of the present invention in which the metallic waveguide 14 is partially inside of the dielectric waveguide 12. In that embodiment the coupling between the waveguides 12, 14 may not be as efficient as other embodiments of the present invention, although it may offer other advantages such as a more compact package and the suppression of certain propagation modes. In this embodiment the metallic waveguide 14 extends beyond the dielectric waveguide 12, although in other embodiments the metallic waveguide 14 may be flush with or recessed into the dielectric waveguide 12.

FIG. 12 is a cross-sectional view of another embodiment of the present invention in which the metallic waveguide 14 is inside of or enclosed by the dielectric waveguide 12. Unlike the previous embodiment, in this embodiment the metallic waveguide 14 is not in contact with and the interior surface of the dielectric waveguide 12. The dielectric material 18 may be, for example, air or other dielectric materials as those described herein.

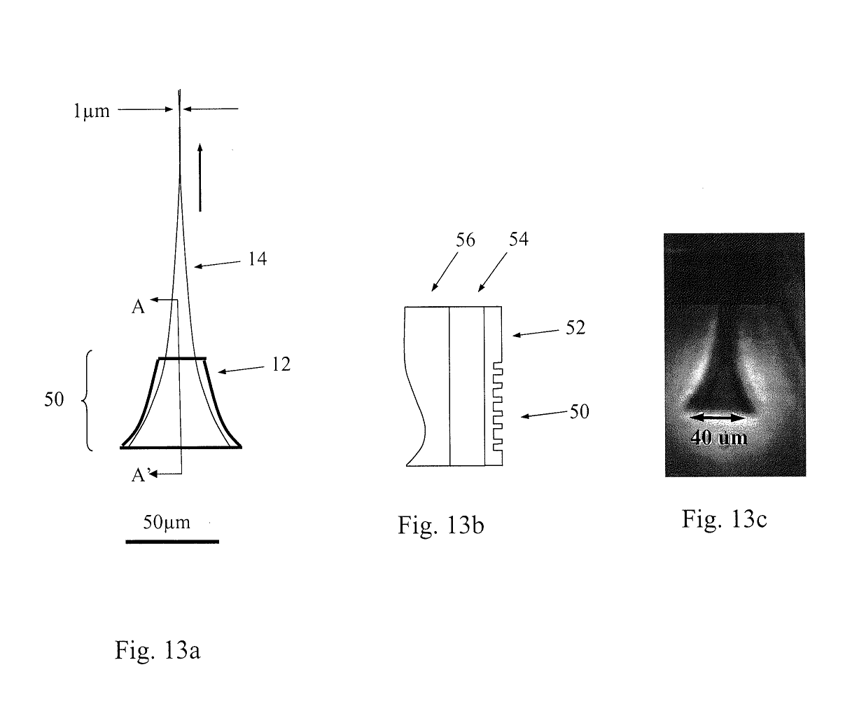

FIGS. 13a-13c illustrate details of one embodiment of the present invention. FIG. 13a illustrates a tapered dielectric waveguide 12 suitable for creation of single mode illumination according to the present invention. FIG. 13b illustrates a schematic of the cross-section of the waveguide including the coupling grating 50. FIG. 13c illustrates a view of the grating 50 illuminated with a laser spot.

The present invention will be described in terms of single mode waveguides, although the present invention may be used with multiple mode waveguides. For example, illumination of the transducer with a single optical mode propagating in a dielectric waveguide of rectangular cross section 12 (width<1 μm) is envisioned. Input of light to this type of waveguide is accomplished using an input grating coupler as has been done by others previously. This grating 50 feeds a tapered waveguide 14 that narrows to a single mode region. If a straight grating 50 is used with an input beam size as shown in the figure (about 40 μm FWHM), then this type of taper may be inefficient to the point that it is unacceptable for some applications. Instead, the present invention may include a weak focusing element to allow such a large compression ratio (40:1) in the taper. For example, a mode index lens or focusing grating coupler (curved grating). Finally, while this input scheme (far field illumination of a grating with a focused spot) is used for testing, we ultimately envision an integrated vertical cavity surface emitting laser (VCSEL) on the slider. With the transducer efficiency reported below, we anticipate that a VCSEL with a 50 μm diameter emission region should be sufficient to provide adequate power, if coupling and focusing can be accomplished with reasonable efficiency.

Several aspects of a variety of near field transducer designs have been examined in simulation: efficiency, spot size, heating efficiency of the media, parasitic heating of the transducer, and the sensitivity of these parameters to the dimensions of the transducer and the optical wavelength. The transducer efficiency is computed as the ratio of the power input to the dielectric waveguide and the power delivered to the media within the full width half maximum (FWHM) of the heated zone. It should be noted that, in some cases, additional power reaches the media, but is outside the hot spot and does not contribute to heating the recording area.

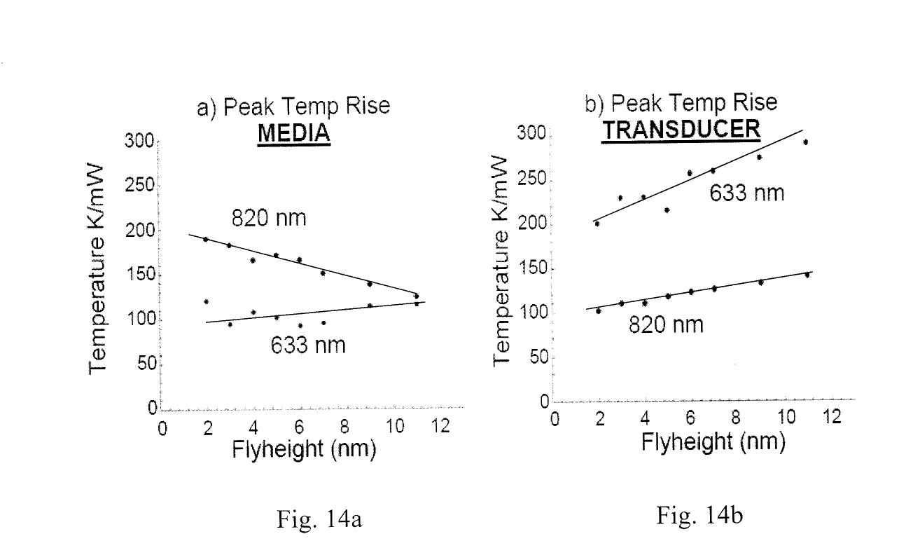

FIG. 14 summarizes several of these parameters for one embodiment of the present invention. These simulations suggest this transducer (gold) experiences much less parasitic heating at the longer wavelength. It is also relatively insensitive to fly height. This transducer produced a spot size that was about 50-60 nm FWHM in all of the cases examined. The spot size showed a weak increase with fly height (not shown). FIG. 14a shows how the temperature of the media 26 and FIG. 14b shows how the temperature of the transducer 14 varies with fly height. The dependence is modest and reasonably monotonic, suggesting an acceptable degree of sensitivity. It should be noted that this particular design is almost completely insensitive to lapping height. More importantly, though, is the dependence of the heating on free space optical wavelength of the illuminating light. Light at 820 nm is significantly more efficient at heating the media than 630 nm (2×) and heats the transducer 14 (made of gold) by only half as much. Heating in the transducer 14 increases as fly-height increases, while heating of the media 26 decreases. Finally, it should be noted that the absolute efficiency of the heating is attractive. With peak temperature rises in the media 26 of over 150 K/mW of power (referenced to the input of the dielectric waveguide), this design would need less than 5 mW of power incident on the transducer 14. In this simulation, thermal conductivities of the media 26 were in a range acceptable for high speed operation of the drive, and power transfer efficiencies were around 3% (power in hot spot/power into dielectric input).

### 1 EXEMPLARY EMBODIMENTS

The present invention will now be described in more detail and in terms is of several other specific embodiments. These embodiments are illustrative of the present invention and the present invention is not limited to these embodiments. The present invention will generally be described in the context of a Near Field Transducer (NFT) for delivering sub-diffraction limit optical spot sizes in near field writing applications, although the present invention may be used in other applications.

In one embodiment, the metallic waveguide 14 in the NFT is a wire with a length on the order of microns and cross sectional dimensions on the order of tens of nanometers. However, many variations are possible with the present invention and other dimensions and other variations are also possible.

The cross sectional shape of the wire 14 defines the nature of the optical spot. In the following embodiments the NFT is excited by coupling a waveguide mode from a traditional dielectric waveguide 12 in close proximity to the wire 14 (Otto Configuration). The coupling between the waveguide 12 and wire 14 can be nearly 100% efficient.

Surface plasmon (SP) activity has been shown to substantially increase the transmission through sub-wavelength apertures and result in field enhancement of nano-antennae [See H. J. Lezec, A. Degiron, E. Devaux, R. A. Linke, L. Martin-Moreno, F. J. Garcia-Vidal, T. W. Ebbesen “Beaming Light from a Subwavelength Aperture” Science, 297, (2002)]. Two well known geometries that exist for efficient excitation of SPs are the Kretchmann and Otto geometries [See E. Kretschmann, H. Raether, “Radiative Decay of Non-Radiative Surface Plasmons Excited by Light” N. Naturf A, 23, pp 2135, (1968)][See A. Otto “Excitation of Nonradiative Surface Plasma Waves in Silver by the Method of Frustrated Total Reflection” Z. Physik, 216, pp 398-410, (1968)]. These geometries will now be briefly described because they may be used with the present invention.

1.1 The Kretchmann Geometry

In the Kretchmann geometry, a dielectric material with a real refractive index n_{H} is coated with a thin layer of metal with complex dielectric index n_{M}. A second dielectric of lower real refractive index n_{L} is deposited on the other side of the metal film. A plane wave with magnetic field transverse to the plane of incidence (TM) on the n_{H}/n_{M} interface will excite SPs at the n_{M}/n_{L}, interface. Provided that the angle θ with the normal of the dielectric metal interfaces and the thickness of the metal film are correctly chosen, the SP effective mode index can be matched to the free space effective mode index and evanescently coupled across the metal.

1.2 The Otto Geometry

The Otto configuration is similar to the Kretchmann configuration but the positions of the metal and low index dielectric are interchanged. In this case, the incident wave in the high index layer is totally reflected by the n_{H}/n_{L} interface in fashion similar to that of the guided mode of a dielectric waveguide. The SP is excited on the n_{L}/n_{M}/interface by evanescent coupling through the low index layer when the effective mode index of the SP and totally reflected wave match and the thickness of the low index layer is correctly chosen.

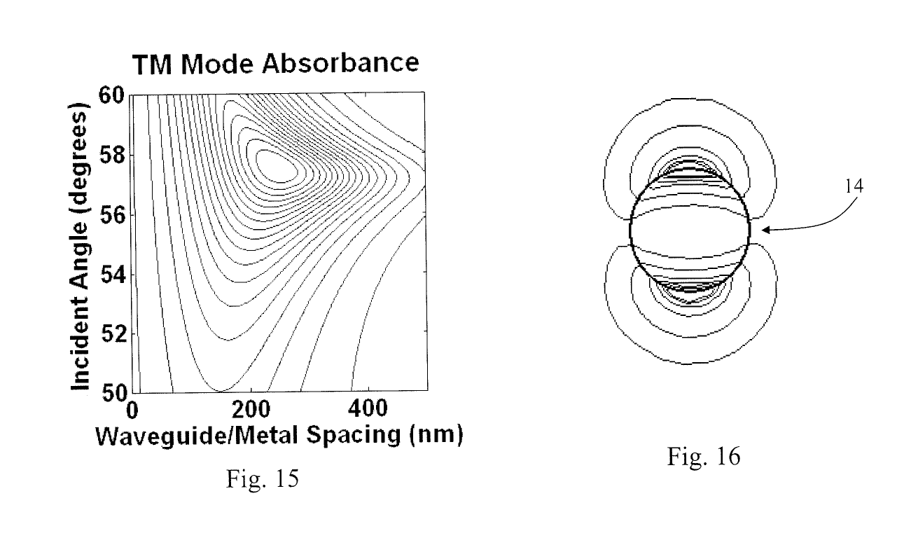

Thin film transmission matrix methods can be employed to calculate the nominal coupling angle and layer thickness provided that the optical constants of the materials at the chosen wavelength are well known. An example of the calculated surface plasmon resonance as a function of angle and low index layer thickness is shown in FIG. 15 The materials are silicon nitride (SiNₓ) with index n_{H}=1.93, silicon dioxide (SiO₂) with index n_{L}=1.458 and gold with complex index n_{M}=0.12−i*3.3. The free space wavelength of the incident light is 632.8 nm and the thickness of the SiO₂ layer is varied on the horizontal axis while the angle of incidence in the SiNₓ layer is varied on the vertical axis. The peak absorption of the TM wave corresponds with optimal SP excitation.

1.3 N_{eff}

The effective mode index n_{eff} relates the free space wavenumber k=2π/λ to the propagation constant β parallel to the interfaces by β/k=n_{eff}. In the SiNₓ, n_{eff}=n_{H}*sin(θ) and thus can take on a continuum of values from 0 to n_{H}. For values of n_{eff} greater than n_{L}, the wave is totally reflected at the n_{H}/n_{L} boundary. To evanescently couple to the SP mode at the n_{L}/n_{M} interface, the n_{eff} of the plasmon mode must lie between n_{L} and n_{M}. It is important to note that the SP n_{eff} will always be higher than the index of the dielectric at the n_{L}/n_{M} interface. This means that there is no way to directly excite the SP mode by steering the incident wave onto the n_{L}/n_{M} interface as n_{eff}/of the wave in the dielectric will be less than n_{L}.

In a dielectric waveguide, the values of n_{eff} that are guided all lie between n_{L} and n_{H}. In addition, the modes of the waveguide are discreet, resulting in discreet values of n_{eff}. As the dimensions of the waveguide are reduced, the number of modes also reduces until all modes are cut off (their n_{eff} drops below n_{L} and they become unguided). A single mode dielectric waveguide supports only one value of n_{eff} that lies between n_{L} and n_{H}. The exact value of n_{eff} can be manipulated by sizing the waveguide appropriately [See K. Okamoto, Fundamentals of Optical Waveguides (Second Edition), Academic Press, (2006)]. This enables the matching of a waveguide mode to a SP mode via fabrication geometry as opposed to incident angle as in the classical Otto geometry. We call this system the Quasi-Otto geometry.

1.4 Coupled Mode Theory

Coupled mode theory (CMT) is used to calculate the coupling efficiency and characteristic coupling length for two waveguide structures to transfer power between their individual modes. The details of CMT are well documented in the literature [See K. Okamoto, Fundamentals of Optical Waveguides (Second Edition), Academic Press, (2006)]. One of the principle results from CMT is that when the waveguides are sufficiently separated, the efficiency of coupling between the two waveguides can be written as:

$$Eff = \frac{1}{1 + {( δ / κ )}^{2}} \qquad ( 1 )$$

where δ is the half-difference in propagation constants and κ is the overlap integral of the two modes electric field profiles within each guide. The coefficient δ can be expressed in terms of the difference in effective mode index as:

$$δ = \frac{{β}_{1} - {β}_{2}}{2} = \frac{π}{λ} ( {n}_{eff 1} - {n}_{eff 2} ) \qquad ( 2 )$$

where β is the mode propagation constant and lambda is the free space wavelength. These relationships show that as long as k is not small (compared to the β mismatch), if the propagation constants of two modes in arbitrary waveguides can be made to match, the efficiency of coupling can become unity. When the propagation constants of the waveguides are matched, the characteristic coupling length L_{C} of the waveguides is equal to 2π/κ.

These relationships are derived for the case of lossless waveguides with purely real n_{eff} values. For dielectric materials the lossless approximation is valid. Metals at optical frequencies have complex dielectric constants and can thus be lossy. Care must be taken to avoid modes whose n_{eff} value has a large loss component (imaginary part).

### 2. DESIGN METHOD

2.1 Boundary Mode Analysis

The design of the coupled plasmonic waveguide centers on matching the n_{eff} values of the SP plasmonic mode within the metallic SP waveguide 14 and the dielectric waveguide 12 mode. Since the plasmonic waveguide 14 is a long thin metallic structure of constant cross section, we sometimes refer to the SP modes, below, within the waveguide as wire modes. In both cases single mode behavior is desired to simplify analysis. Analytical calculation of the mode structure is possible for simple geometries. However, more realistic or exotic guide shapes rapidly become cumbersome to evaluate by hand. The commercial finite element modeling package COMSOL is used to locate the modes of each system individually and determine the sizing of the wire and waveguide needed for good coupling.

Boundary mode analysis (BMA) calculates the effective index and electromagnetic field profile of the modes from a given waveguide cross section. FIG. 16 shows a BMA of a circular wire 14 isolated in a dielectric medium. The effective index of the wire mode is 1.521. The wire cross section is chosen so that the power flow normal to the cross section has a shape similar to the desired spot in the media. In addition, the wire shape is tuned to so that the SP mode's effective index is close to cutoff. This ensures that the loss of the SP mode is minimized and that the dielectric waveguide 12 can be sized to match the n_{eff} value of the wire mode. The boundary conditions at the perimeter of the BMA region should be unimportant for a truly guided mode. This can be checked by cycling the boundary conditions (perfect electric, perfect magnetic and scattering) in COMSOL and observing how n_{eff} of the mode changes. If the boundary conditions shift n_{eff} significantly, either the mode being observed is not truly guided or the simulation space is too small. Although this analysis uses a waveguide 14 with a circular cross-section, other cross-sectional shapes may also be used.

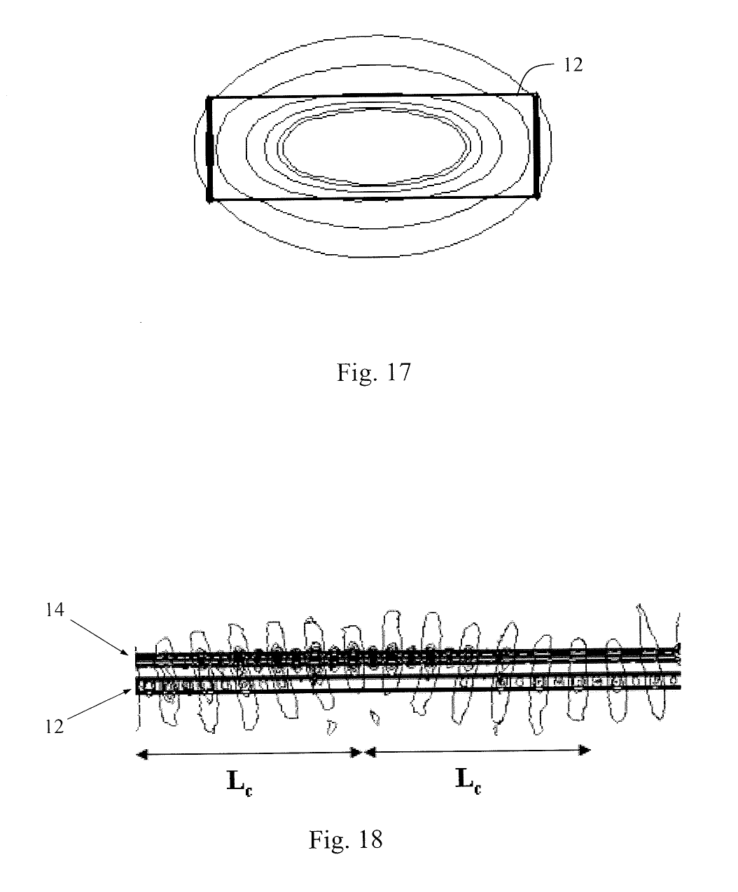

Once the plasmonic waveguide cross section and the n_{eff} of its plasmon mode determined, the rectangular dielectric waveguide 12 can be sized using BMA. Although the dielectric waveguide 12 is described as being rectangular, it may also have other cross-sectional shapes. FIG. 17 shows the quasi-transverse magnetic waveguide mode in the waveguide. In this simulation, the “wire” has been ‘turned off’ by setting its refractive index to that of the ambient (cladding) index. By manipulating the height and width of the rectangular waveguide 12, the lowest order TM-like mode can have its n_{eff} value matched to the real part of the SP n_{eff} value for the wire. Again, the boundary conditions should be checked to ensure they are not perturbing the result.

The final step in BMA is to gain an estimate for initial spacing of the wire 14 and dielectric waveguide 12. This is done by placing the wire 14 and dielectric waveguide 12 in the simulation space and performing BMA. If the wire 14 and waveguide 12 are widely spaced, they BMA will locate a mode where both are simultaneously excited with n_{eff} equal to their individual mode indexes. In this situation, the waveguides 12, 14 are effectively isolated from one another. As the waveguides 12, 14 are moved closer together, their joint n_{eff} value found from BMA will rise as the modes become mutually guiding. When the wire 14 and dielectric waveguide 12 are too close, the field structure of their joint modes will no longer look like a simple superposition of the two individual modes. Our starting separation estimate has mode fields that are unperturbed and joint n_{eff} raised by 10% over the individual n_{eff} values.

2.2 Coupling Length Analysis

The two dimensional cross section used in BMA can be directly extruded into a three dimensional (3D) space in COMSOL. A total extrusion length of 5 μm is usually sufficient to show complete coupling at optical frequencies. If the node-count in a 3D simulation makes solving the 3D system difficult, the space can be cut in half by exploiting the mirror symmetry down the propagation axis. The perfect magnetic boundary condition in COMSOL is used to create minor symmetry for the quasi-transverse magnetic modes of this system.

The guided mode is launched in the dielectric waveguide 12 using the results from the BMA of the dielectric waveguide 12 alone. A cross section of this simulation is shown in FIG. 18. The power in the waveguide mode is coupled into the SP mode over the characteristic coupling length L_{C}. The decay length can also be estimated by integrating the power in cross sections down the propagation axis of the waveguide/wire system. Both properties can be manipulated by adjusting the separation between the wire 14 and waveguide 12. In general, the decay length and coupling length decrease as the wire 14 and waveguide 12 are brought closer together. The wire 14 waveguide 12 separation is optimized when the coupling length is minimal but net power transferred to the SP mode is maximized.

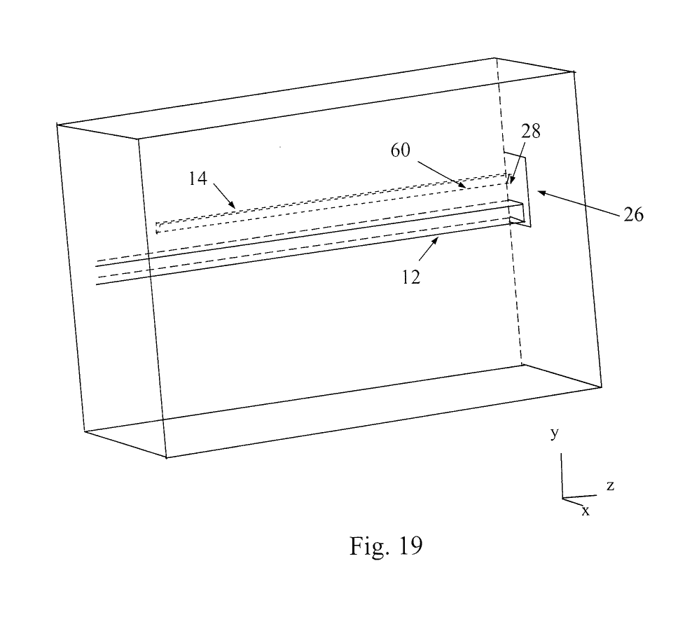

FIG. 19 shows a half space view of a plasmonic waveguide according to one embodiment of the present invention. The embodiment shows a specific device configuration in which the power travels along the narrow ridge 60 at the bottom of the waveguide 14, having, in this case, a trapezoidal cross section. As a result of the configuration, the power is concentrated in a relatively narrow region, resulting in a relatively high power density. In other embodiments, the power density may be lower. FIG. 19 shows the power flow (Poynting vector) in the direction of flow toward the media 26 (z-direction in figure). In this simulation, the power is coupled in from a dielectric waveguide 12 through matching of the propagation constants as described above.

2.3 Media Hot Spot Analysis

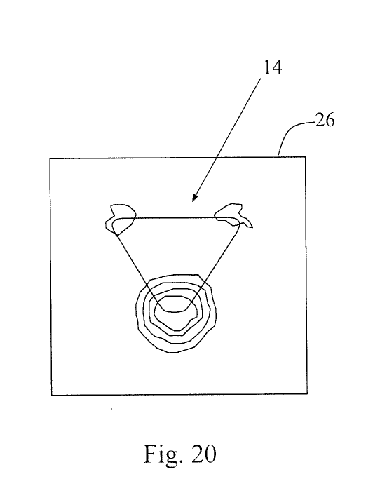

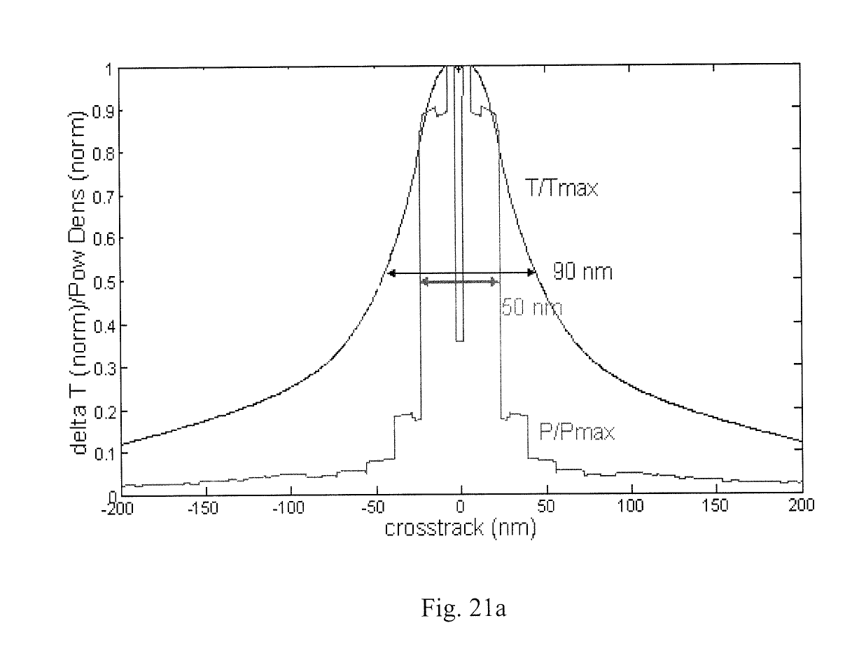

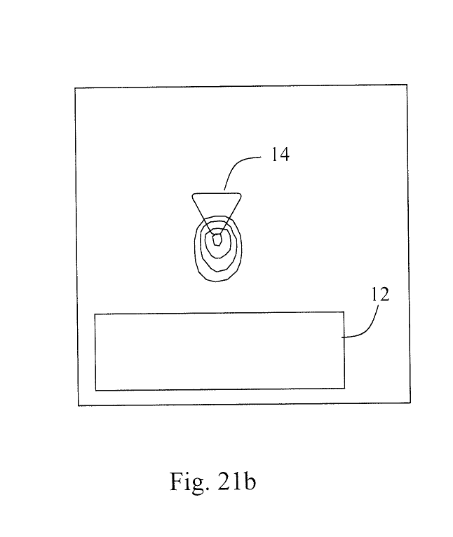

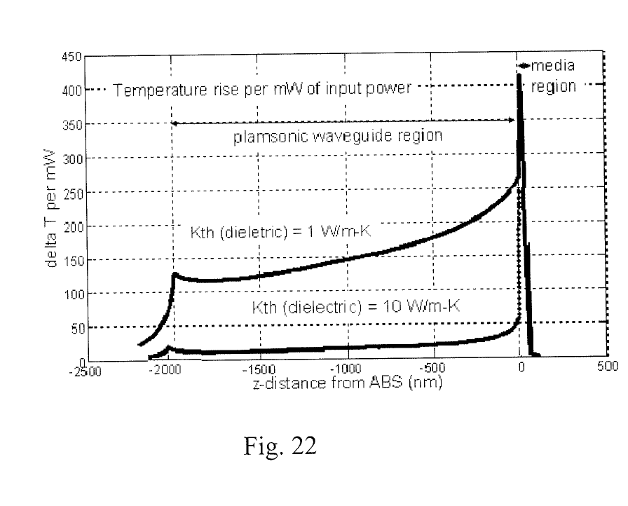

Once the optimal coupling length is determined, the 3D simulation is truncated so that the total wire 14 length is equal to the coupling length “l”. An air bearing and media stack 26 is incorporated into the model using optical constants appropriate for thin films. In this geometry, the power flow out of the simulation boundaries can be integrated to highlight scattering and reflections. Inside the simulation domain, the real part of the divergence of the Poynting vector constitutes power absorption. The absorption can be integrated to trace where power is dissipated in the system. FIG. 20 shows a plot of the power dissipation in the media 26 one nm below the media 26 surface for a trapezoidal wire 14 cross section. The power dissipation forms the source term for thermal simulations of heating in the media 26 and plasmonic waveguide 14. An example of such an analysis is shown in FIGS. 21a and 21b, which shows both the electric power dissipation and the resulting thermal profile in the media 26. It should be noted that the temperature profile is substantially broader than the dissipated power profile. This is due to lateral heat flow in a non-optimized media 26 stack (in terms of thermal properties). FIG. 21b shows contours of the temperature distribution in the plane of the media 26, with the bottom ridge of the triangular transducer having highest temperature. FIG. 22 shows an analysis of the temperature in the plasmonic waveguide 14 and the media as a function of position along the waveguide 14. It is noted that the temperature of the media 26 is higher than the waveguide 14 (which is desirable) and can be much higher if the thermal conduction of the dielectric material surrounding the waveguide is high.

### 3. EXEMPLARY VARIATIONS

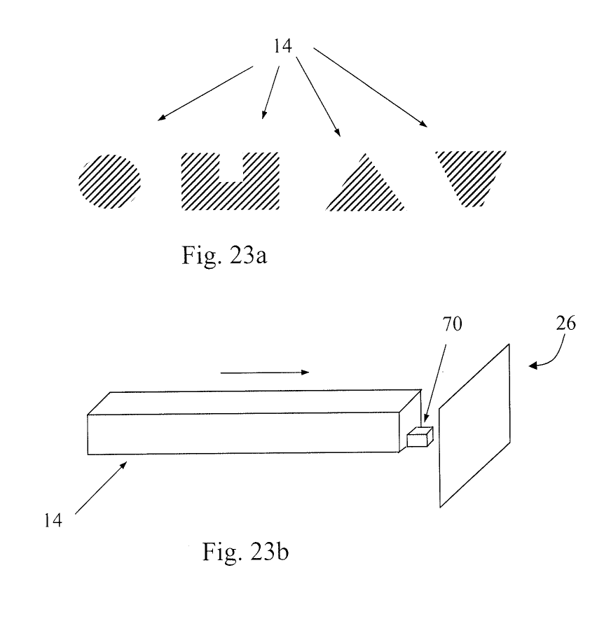

The BMA method lends itself to the consideration of many different possible wire 14 cross sections. We have considered rectangular, ellipsoidal, trapezoidal, T-shaped and grooved plate cross sections and all can be sized to meet the n_{eff} range available to the dielectric waveguide 12. In the full 3D model, different terminations of the wire 14 can also be considered, such as apertures or ‘beak’ structured terminations. FIG. 23a shows a series of different cross sections of the plasmonic waveguide 14 that will work, and can be easily excited with a dielectric waveguide 12 in proximity. FIG. 23b shows an example of protrusion 70 from a generic plasmonic waveguide 14 that could be used to concentrate field in the media 26. The arrow running parallel to the top of the plasmonic waveguide 14 illustrate the direction in which energy is propagating the waveguide 14 in this embodiment.

### 4. VALIDATION EXPERIMENTS

4.1 Measuring Decay Length and Coupling Length Experimentally.

It is believed that the measurement of the decay length and coupling length can be accomplished by fabrication of the structure simulated during the coupling length analysis (Section 2.2). A long (several mm) dielectric waveguide 12 with an approximately 20 μM wire segment 14 above it (˜100 nm separation) would be embedded in a SiO₂ cladding. If the coupling length and decay length are sufficiently long, high quality microscope instruments could detect the scattered light from the waveguide/wire. If greater resolution is required, a scanning near-field optical microscope (SNOM) can be used to detect the evanescent fields extending beyond the wire and waveguide.

4.2 Spot Size on Phase Change or HAMR Media

The spot size in the media is perhaps best characterized using the NFT to write marks in the desired recording media as the coupling between the NFT and media is critical.

### 5. METHODS

Although the present invention has generally been described in terms of specific embodiments of apparatuses, the present invention also includes methods.

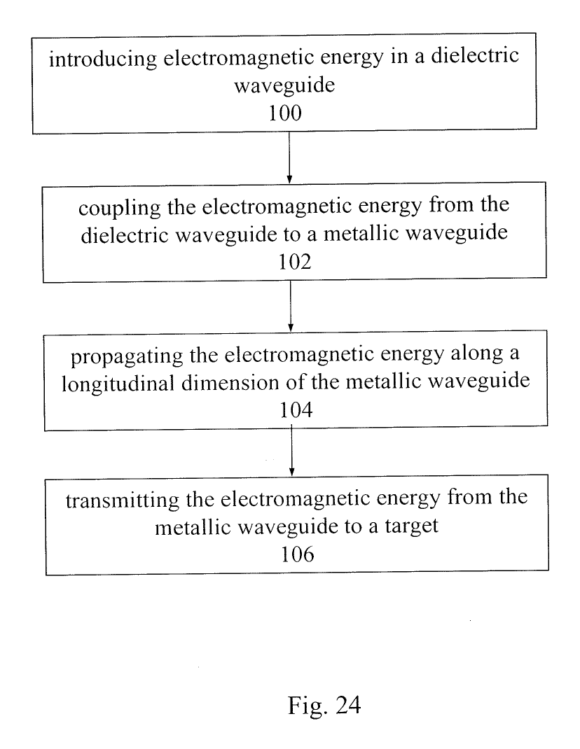

FIG. 24 illustrates one embodiment of a method according to the present invention.

Step 100 includes introducing electromagnetic energy in a dielectric waveguide 12. The dielectric waveguide may have an effective mode index, and the electromagnetic energy may propagate along a longitudinal dimension of the dielectric waveguide 14 as described previously.

Step 102 includes coupling the electromagnetic energy from the dielectric waveguide 12 to a metallic waveguide 14. This couple may occur at a location where the metallic waveguide 14 and the dielectric waveguide 12 are adjacent to each other and overlap each other by a length along longitudinal dimensions of both the dielectric waveguide 12 and the metallic waveguide 14. As described above, the “length” is greater than the wavelength lambda in the metallic waveguide 14.

Step 104 includes propagating the electromagnetic energy along a longitudinal dimension of the metallic waveguide 14. The electromagnetic energy may be in a surface plasmonic mode of propagation in the metallic waveguide 14 and at a wavelength lambda.

Many variations are possible with the method of the present invention, as is apparent from the above description. Several specific variations will be described, although this description is illustrative of the present invention and not limiting.

In one embodiment, coupling the electromagnetic energy from the dielectric waveguide 12 to the metallic waveguide 14 (step 102) includes inducing a surface plasmonic mode of propagation on a surface of the metallic waveguide 14 that is not facing the dielectric waveguide 12. This aspect of the present invention was previously described and may be effected, for example, with the use of a dielectric material 30 on the surface of the metallic waveguide 14 that faces the dielectric waveguide 12.

In another embodiment, the surface plasmonic mode of propagation in the metallic waveguide 14 has an effective mode index, and the effective mode index of the surface plasmonic mode of propagation is matched to the effective mode index of the dielectric waveguide 12.

In another embodiment, propagating the electromagnetic energy along a longitudinal dimension of the metallic waveguide (step 104) includes propagating the electromagnetic energy in only one plasmonic mode of propagation.

In another embodiment, propagating the electromagnetic energy along a longitudinal dimension of the metallic waveguide (step 104) includes propagating the electromagnetic energy in more than one plasmonic mode of propagation.

In another embodiment, the method includes a further step (step 106) of transmitting the electromagnetic energy from the metallic waveguide 14 to a target 26. This further step is performed after step 104, propagating the electromagnetic energy along a longitudinal dimension of the metallic waveguide 14. As described in more detail above, this step may include transmitting the electromagnetic energy to another waveguide or to magnetic media or other targets 26.

Other variations and modifications of the method of the present invention are also possible.

### 6. COMPUTER-IMPLEMENTED EMBODIMENTS

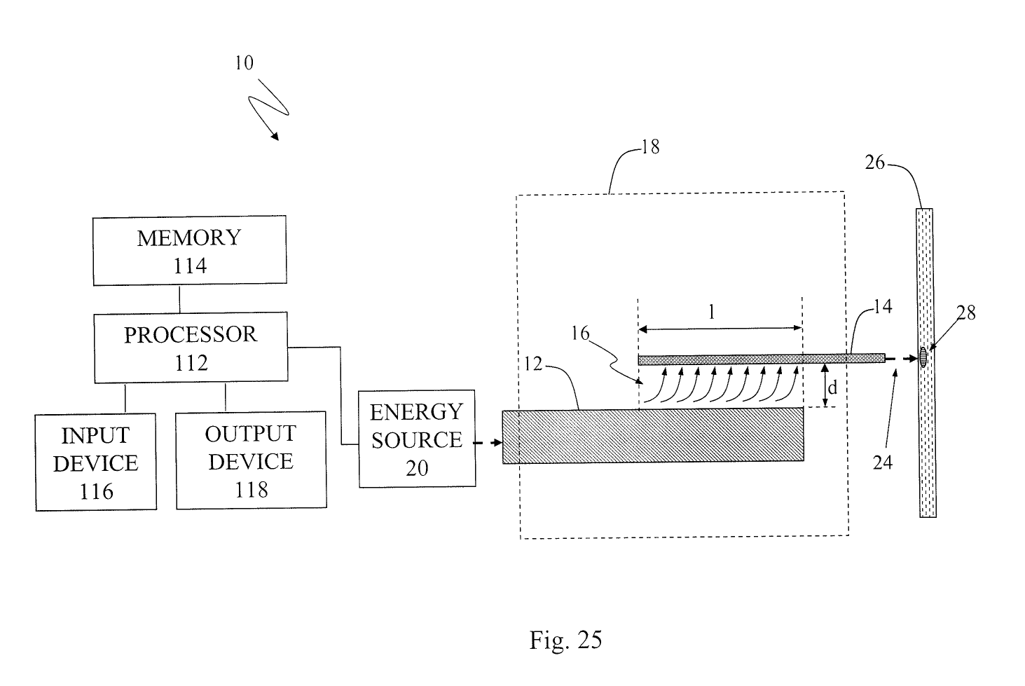

FIG. 25 illustrates another embodiment of the apparatus 10 according to the present invention. In that embodiment, the apparatus 10 includes a processor 112, memory 114, an input device 116, and an output or display device 118, such as a monitor. The processor 112 is connected to the memory 114, the input device 116, and the output device 118. The memory 114 includes computer readable instructions, such as computer hardware, software, firmware, or other forms of computer-readable instructions which, when executed by the processor 112, cause the processor 112 to perform certain functions, as described herein.

The processor 112 receives input from the input device 116, and provides signals to control the output device 118 and the energy source 20. In other embodiments, the processor 112 may be used to control other devices in place of or in addition to the energy source 20. The processor 112 may also receive input from other sources, such as feedback from the target 26, or instructions or feedback from other devices. The processor 112 may also perform other functions, as described herein.

The memory 114 can be any for of computer-readable memory, and may store information in magnetic form, optical form, electrical form, or other forms. The memory includes computer readable instructions which, when executed by the processor 112, cause the processor 112 to perform certain functions, as described herein. The memory 114 may be separate from the processor 112, or the memory 114 may be integrated with the processor 112. The memory 114 may also include more than one memory device, which may be integrated with the processor 112, separate from the processor 112, or both.

The input device 116 may be a keyboard, a touchscreen, a computer mouse, or other forms of inputting information from a user. The input device 116 may also be used for inputting information from a source other than a human user, such as a data port.

The output device 118 may be a video display or other forms of outputting information to a user. The output device 18 may also be lights, speakers, or other forms of output that can be used to convey information to, or to get the attention of, a user. The output device 118 may also be used for outputting information to something other than a human user, such as a data port.

Many variations are possible with the apparatus 10 according to the present invention. For example, more than one processor 112, memory 114, input device 116, and output device 118 may be present in the apparatus 10. In addition, devices not shown in FIG. 25 may also be included in the apparatus 10, and devices shown in FIG. 25 may be combined or integrated together into a single device, or omitted.

For example, the present invention may be embodied as a magnetic memory disk drive in which the processor 112 and the memory 114 are part of a controller for the drive. In that embodiment, human input and output devices 116, 118 may not be present, although input and/or output devices 116, 118 for use by computers may be present to allow the apparatus to communication with other processors or controllers. Also in that embodiment, the processor 112 may receive input or feedback from other parts of the device or from other devices, such as instructions to write data to a magnetic surface 26 in the drive, the position of a write head or other device relative to a rotating disk 26 or other part in the drive, and other feedback and input.

The present invention may be embodied in many forms. For example, the present invention may be an embedded system such as software on a chip. In another embodiment, the present invention may be embodied as one or more devices located in one or more parts of the invention illustrated in FIG. 25. For example, the present invention may be embodied as computer-readable instructions (e.g., software on a chip, software in a portable or integrated memory device, hard-wired instructions embodied in a hardware device, or other variations). In another embodiment, the present invention may be embodied as one or more discrete computers. The present invention may also be embodied as computer-readable instructions (e.g., computer software, firmware, or hardware). The computer-readable instructions may be stored in memory devices which may be integrated or embedded into another device, or which may be removable and portable. Other variations and embodiments are also possible.

### 7. CONCLUSION

Although the present invention has generally been described in terms of specific embodiments and implementations, the present invention is applicable to other methods, apparatuses, and technologies and the examples provided herein are illustrative and not limiting. In addition to the examples provided herein, other variations and modifications of the present invention are possible and contemplated, and it is intended that the foregoing specification and the following claims cover such modifications and variations.

1. An apparatus, comprising:
a dielectric waveguide having an effective mode index and having a longitudinal dimension;
a metallic waveguide having a longitudinal dimension, wherein:
the metallic waveguide supports a surface plasmonic mode of propagation for a wavelength lambda;
the metallic waveguide and the dielectric waveguide are adjacent to each other and overlap each other by a length along the longitudinal dimensions of both the dielectric waveguide and the metallic waveguide, wherein the length is greater than the wavelength lambda in the metallic waveguide; and
the metallic waveguide is coupled to the dielectric waveguide where the metallic waveguide and the dielectric waveguide overlap each other.

2. The apparatus of claim 1, wherein the metallic waveguide is separated from the dielectric waveguide by a distance where the metallic waveguide and the dielectric waveguide overlap each other, wherein the distance is that at which energy at wavelength lambda is coupled from the dielectric waveguide to the metallic waveguide.

3. The apparatus of claim 1, the metallic waveguide includes a dielectric material on a surface of the metallic waveguide between the metallic waveguide and the dielectric waveguide.

4. The apparatus of claim 3, wherein:
the metallic waveguide has a triangular shape with a flat surface oriented towards the dielectric waveguide and an angled surface oriented away from the dielectric waveguide;
the dielectric material is on the flat surface oriented towards the dielectric waveguide; and
the surface plasmonic mode of propagation in the metallic waveguide is on the angled surface of oriented away from the dielectric waveguide.

5. The apparatus of claim 1, wherein the metallic waveguide is in contact with the dielectric waveguide where the metallic waveguide and the dielectric waveguide overlap each other.

6. The apparatus of claim 5, wherein the surface plasmonic mode of propagation in the metallic waveguide is on a surface of the metallic waveguide that is not in contact with the dielectric waveguide.

7. The apparatus of claim 6, wherein there is no surface mode of propagation in the surface of the metallic waveguide that is in contact with the dielectric waveguide.

8. The apparatus of claim 1, wherein the metallic waveguide is in surrounded by the dielectric waveguide where the metallic waveguide and the dielectric waveguide overlap each other.

9. The apparatus of claim 1, wherein the surface plasmonic mode of propagation has an effective mode index, and the effective mode index of the surface plasmonic mode of propagation is matched to the effective mode index of the dielectric waveguide.

10. The apparatus of claim 1, wherein the metallic waveguide supports only one plasmonic mode of propagation.

11. The apparatus of claim 1, wherein the metallic waveguide supports more than one plasmonic mode of propagation.

12. The apparatus of claim 2, further comprising a dielectric material between the dielectric waveguide and the metallic waveguide.

13. The apparatus of claim 1, wherein the dielectric waveguide has an input and the metallic waveguide has an output, and further comprising:
an energy source having an output coupled to the input of the dielectric waveguide; and
a target oriented to receive energy from the output of the metallic waveguide.

14. The apparatus of claim 1, wherein the metallic waveguide and the dielectric waveguide are both adjacent to and parallel to each other by a length along the longitudinal dimensions of both the dielectric waveguide and the metallic waveguide.

15. The apparatus of claim 1, wherein the metallic waveguide includes at least one tuning feature to facilitate impedance matching and energy transfer.

16. The apparatus of claim 15, wherein the feature facilitates impedance matching and energy transfer to the target.

17. The apparatus of claim 15, wherein the feature facilitates impedance matching and energy transfer to the dielectric waveguide.

18. The apparatus of claim 15, wherein the tuning feature is physically attached to the metallic waveguide.

19. The apparatus of claim 16, wherein the tuning feature is not physically attached to the metallic waveguide.

20. A method of coupling energy, comprising:
introducing electromagnetic energy in a dielectric waveguide having an effective mode index, wherein the electromagnetic energy propagates along a longitudinal dimension of the dielectric waveguide;
coupling the electromagnetic energy from the dielectric waveguide to a metallic waveguide at a location where the metallic waveguide and the dielectric waveguide are adjacent to each other and overlap each other by a length along longitudinal dimensions of both the dielectric waveguide and the metallic waveguide, wherein the length is greater than the wavelength lambda in the metallic waveguide; and
propagating the electromagnetic energy along a longitudinal dimension of the metallic waveguide, wherein the electromagnetic energy is in a surface plasmonic mode of propagation in the metallic waveguide and at a wavelength lambda.

21. The method of claim 20, wherein coupling the electromagnetic energy from the dielectric waveguide to the metallic waveguide includes inducing a surface plasmonic mode of propagation on a surface of the metallic waveguide that is not facing the dielectric waveguide.

22. The method of claim 20, wherein the surface plasmonic mode of propagation has an effective mode index, and the effective mode index of the surface plasmonic mode of propagation is matched to the effective mode index of the dielectric waveguide.

23. The method of claim 20, wherein propagating the electromagnetic energy along a longitudinal dimension of the metallic waveguide includes propagating the electromagnetic energy in only one plasmonic mode of propagation.

24. The method of claim 20, wherein propagating the electromagnetic energy along a longitudinal dimension of the metallic waveguide includes propagating the electromagnetic energy in more than one plasmonic mode of propagation.

25. The method of claim 20. further comprising after propagating the electromagnetic energy along a longitudinal dimension of the metallic waveguide, transmitting the electromagnetic energy from the metallic waveguide to a target.
